(19) United States
(12) Patent Application Publication
(10) Pub. No.: US 2004/0172348 A1
(43) Pub. Date: Sep. 2, 2004

(54) method of issuing tickets with face picture thereon from a data terminal

(75) Inventors: Masami Kawamori, Kanagawa (JP); Kei Suzuki, Kanagawa (JP)

Correspondence Address: SUGHRUE MION, PLLC, J. Frank Osha, 2100 Pennsylvania Avenue, NW, Washington, DC, 20037-3213, US

(73) Assignee: NEC INFRONTIA CORPORATION

(21) Appl. No.: 10/413,207

(22) Filed: Apr. 15, 2003

(30) Foreign Application Priority Data
Feb. 27, 2003 (JP) 051045/2003

(51) Int. Cl. G06F 17/60

(52) U.S. Cl. 705/31

(57) ABSTRACT

[Problems] To provide to provide a method of issuing tickets with face picture thereon from a data terminal, which can issue tickets with face picture thereon with a simple equipment and quickly, and manages customer data including face picture data to permit simple customer's identify confirmation.

[Means for solving the problems] Customer's face picture data, which is imaged by, for instance, an imaging means 2 installed on the side of POS terminal 1, is printed together with ticket data on a ticket to be issued. The face picture data and the ticket data are stored and managed in an upper rank server or the like. On an event place, an outside connection terminal is installed, which is connected via a network server to the upper rank server. The outside connection terminal receives the phase picture data and ticket data stored in the upper rank server and causes display of the received data on a display. In this way, the outside connection terminal makes confirmation of the customer as such.

### BACKGROUND OF THE INVENTION

1. Technical field of Invention

The present invention relates to a method of issuing tickets with face picture from a data terminal such as a POS terminal or the like for issuing tickets with face picture, entrance tickets or the like.

2. Background Art

Tickets of concerts, attraction halls, etc. are frequently sold in advance in advance sales ticket sales shops such as ticket shops and convenience stores. A customer who wants to purchase an advance sales ticket in an advance sales ticket shop of this kind, pays the fee to the shop, receives the receipt therefrom, and obtains the pertinent advance sales ticket on the site or in a separate place.

By the way, many events and entertainments require confirmation of the identity of the customer when the customer enters the site. Also, facilities concerning longtime presence such as large scale amusement parks, which adopt a system of allowing free entrance and exit after confirming the customer's identity and attaching a customer's face picture to the ticket for the customer's identity confirmation, are increasing in number. Regarding such facilities, it has been difficult, in connection to the equipment of the advance sales ticket sales shop, to issue an entrance ticket with face picture at the time of the fee payment. Therefore, when such an entrance ticket with face picture is necessary, the customer brings a payment certificate such as a receipt to the facility with a pertinent equipment to take a picture and applies the face picture thus obtained to the ticket. For example, in a facility in which a large scale attraction prevails, a ticket issuance place with a picturing equipment takes a picture of the customer who comes with a receipt with a digital camera or the like, and applies the picture thus obtained on the ticket to produce a ticket with an integral picture.

A technique for printing a sheet with a face picture with a printer installed on a POS terminal, is disclosed in Japanese patent laid-open No. 11-66437 (FIGS. 1 and 4, paragraphs [0017]-[0024]) (patent reference 1). However, this technique is for issuing a receipt, on which a face picture of an operator operating a POS terminal is simultaneously printed, and is irrelevant to ticket issuance.

### SUMMARY OF THE INVENTION

As described above, as for the purchase or issuance of a ticket with face picture thereon, the customer heretofore purchases a receipt with sole ticket data printed thereon in an advance sales ticket sales shop, and brings the receipt to a place for taking his or her picture and applying the picture to a ticket or producing an entrance ticket with integral picture thereon. This means that some operations are necessary for obtaining the ticket with face picture thereon, that is, a certain time is necessary until the ticket issuance.

In the case of a ticket without any face picture thereon, if the customer who purchased the ticket and the customer who is to enter are not identical, the discrimination can be made on the basis of only self-reported data such as date of birth and age.

Furthermore, the face picture data and the ticket data are not managed. Besides, not only adequate management of data can be made, re-issuance of ticket requires newly taking the customer's face picture, leading to cumbersome operation.

The present invention was made in view of the above background affairs, and an object of the present invention is to provide a method of issuing tickets with face picture thereon from a data terminal, which can issue tickets with face picture thereon with a simple equipment and quickly.

Another object of the present invention is to provide a method of issuing tickets with face picture thereon by a data terminal, which manages customer data including face picture data to permit simple customer's identify confirmation.

In order to solve the above problems, a method of issuing tickets with face picture thereon according to the present invention has the following featured structures.

(1) A method of issuing tickets with face picture thereon from a data terminal, wherein customer's face picture data obtained by imaging with an imaging means installed on the side of the data terminal is printed together with ticket data on a ticket in a printer in the data terminal, the resultant printed ticket being issued, the face picture data and the ticket data being stored for management.

(2) A method of issuing tickets with face picture thereon from a data terminal, wherein a data terminal, an imaging means and a printer are provided on the side of a ticket sales shop, and customer's face picture data obtained by imaging with an imaging means is printed together with ticket data on a ticket to be issued and also transmitted via a network (i.e., communication line) to an upper rank server for storing and management.

(3) The method of issuing tickets with face picture thereon from a data terminal according to the above (2), wherein an outside terminal connected via a network to the upper rank server is installed in a place, in which an event is held, for receiving face picture data and ticket data stored in the upper rank server and displaying the received data on a display for the confirmation of the customer.

(4) The method of issuing tickets with face picture thereon according to one of the above (1) to (3), wherein the data terminal is a POS terminal.

(5) The method of issuing tickets with face picture thereon according to one of the above (1) to (4), wherein the printer is a thermal printer, and the face picture is expressed by density gradation expression.

### BRIEF DESCRIPTION OF THE DRAWINGS

FIG. 1 is a POS terminal unit, which is used in a method of issuing tickets with face picture thereon by a data terminal in an embodiment of the present invention applied to a POS system.

FIG. 2 is a system hierarchy of the POS terminal.

FIG. 3 is an example of ticket with face picture thereon printed by the printer according to the embodiment of the present invention.

FIG. 4 is an example of system configuration implementing a method of issuing tickets with face picture thereon in a data terminal according to the present invention.

FIG. 5 is a flow chart showing the operation routine of the method of issuing tickets with face picture by the data terminal according to the present invention.

### DETAILED DESCRIPTION OF THE PREFERRED EMBODIMENTS OF THE INVENTION

Preferred embodiments of a method of issuing tickets with face picture thereon according to the present invention will now be described with reference to the drawings. In the drawings, the following elements are numbered as:

1 a POS terminal,

2 an imaging means,

3 a printer,

4 a shop server,

5 a headquarter server,

6 an outside terminal,

11 a communicating means,

12 an input selecting means,

13 a storing means,

14 a display, and

15 a control means.

The present invention is based on issuing tickets with face picture thereon by using, for instance, a printer belonging to a POS system. Specifically, customer's face picture data, obtained by imaging in such imaging means as digital camera, and is printed on a ticket on a ticket together with customer's data, kind of ticket, effective term, seat data, etc., advance sales ticket sales processed in a data terminal such as a POS terminal. Ticket data including the face picture data is transmitted from the data terminal such as POS terminal via a communication line such as a network to the side of a central unit to be managed therein.

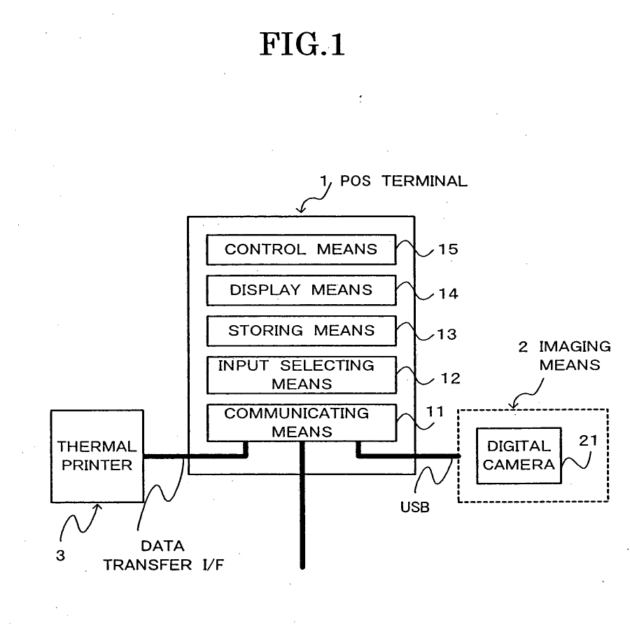

FIG. 1 shows a POS terminal unit, which is used in a method of issuing tickets with face picture thereon by a data terminal in an embodiment of the present invention applied to a POS system. Referring to FIG. 1, an imaging means 2 and a printer 3 are provided as accessory units to a POS terminal 1.

The POS to Final 1 includes a communicating means 11 for transmitting and receiving data to and from the imaging means 2 and the printer 3, an input selecting means 12 such as a keyboard, a storing means 13 for storing face picture data, ticket data, customer data, etc. as well as intrinsic POS data, a display 14 for displaying POS data and desired data (which may as well be a touch panel structure also serving as input means), and a control means 15 for controlling the either POS terminal unit.

The imaging means 2 has, for instance, a digital camera, and it takes a face picture of each customer who purchased a ticket, and transmits the face picture data thus obtained via an interface such as USB to the POS terminal 1.

In the POS terminal 1, the received face picture data is stored via the communicating means 11 in the storing means 13. From the POS terminal 1, desired data such as POS data and face picture data are transmitted via the communicating means 11 and a host line (such as LAN) to the central processing unit side for data management.

The printer 3 serves to print an intrinsic receipt showing POS processed sold item details and also print and issue a ticket or print and issue a ticket with face picture thereon according to the present invention. The printer 3 may also be used in the POS system, and thus it has to be inexpensive and is preferably a thermal printer. For the transmission of density gradation data of face picture from the POS terminal 1 to the printer 3, a data transfer interface (I/F) is provided.

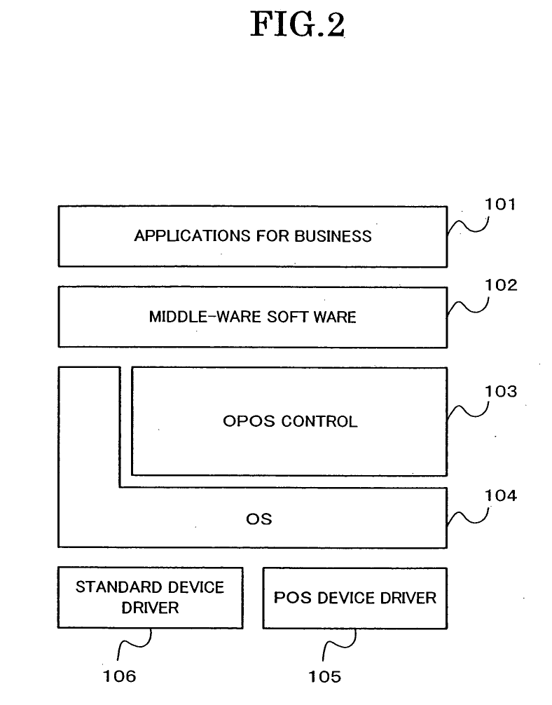

FIG. 2 shows the system hierarchy of the POS terminal. The system hierarchy of a usual POS terminal is constituted by application 101 for business, middle-ware software 102, POS control 103, OS 104, POS device driver 105 and a standard device driver 106. The application to the printing of tickets with face picture thereon according to the present invention is provided as middle-ware software. Thus, the annexing of face photograph to ticket, management of such data as face photograph data and data transmission and reception to and from shop side server can be made in an interlocked relation to the application for business. The application for business may also serve as the application to the printing of ticket with face photograph thereon according to the present invention.

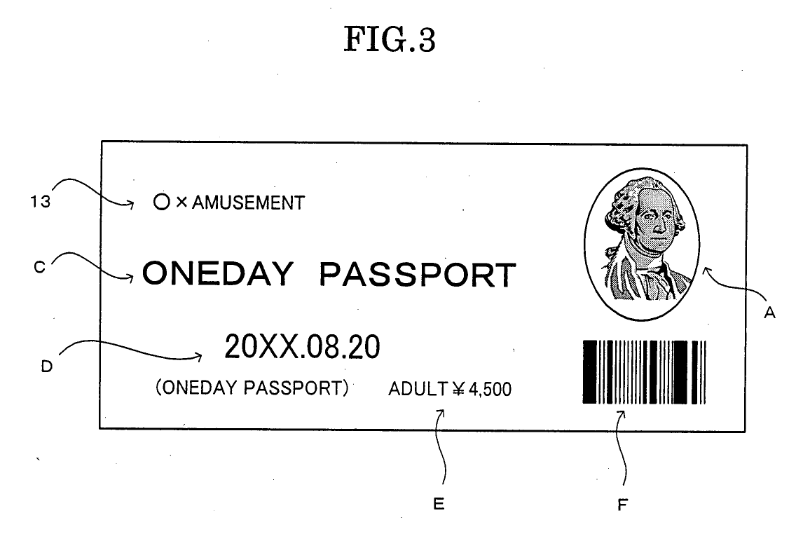

FIG. 3 shows an example of ticket with face picture thereon (i.e., an amusement park ticket) printed in the printer 3. As shown in the figure, a face picture A of the customer who purchased the ticket is printed on a right side part of the ticket. The printing of the face picture may be made in any desired mode including color mode. In this embodiment, as the printer is used an inexpensive thermal printer for clearly printing the face picture of monochromic density gradation.

The thermal printer includes a head with a line-like matrix array of heat generating elements, and in this embodiment a density gradation printing system is adopted, which utilizes the color generation property of heat-sensitive paper sheets for density gradation printing with superimposition of heat energy for each dot.

The name B of facility with the pertinent ticket used therein (i.e., OX amusement park) is printed on a left upper part of the ticket, the kind C of ticket (in this embodiment effective for a day only (i.e., “ONE DAY PASSPORT”) is printed on its lower part, and the effective date D of the ticket (i.e., effective only on August 20, 20xx) and the amount E of entrance fee of adult or child (in this embodiment: Adult: ¥4,500) are printed in a further lower part. On a right lower part, data concerning the ticket (i.e., particular data such as number) is printed as a bar code F).

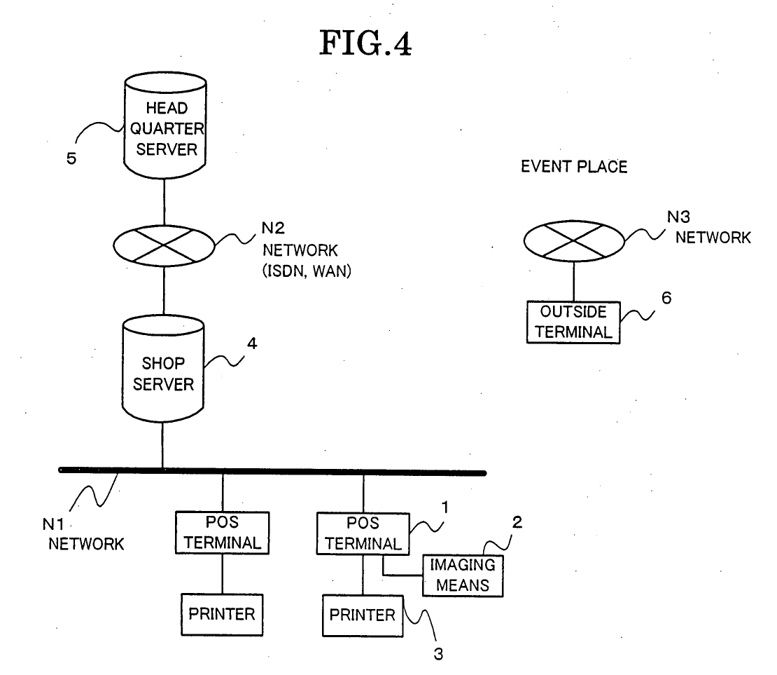

Now, an example of system configuration implementing a method of issuing tickets with face picture thereon in a data terminal according to the present invention will now be described with reference to FIG. 4. A POS terminal 1, an imaging means 2 and a printer 3 are installed on the side of a ticket shop or the like with the POS system introduced therein. The same set is installed in each shop. The POS terminal 1 is connected via a network (communication line) N1 to a shop server 4. The shop server 4 is connected via a network N2 to a headquarter server 5, and it collects data transmitted from the POS terminal 1 and transmits the collected data to the headquarter server 5.

The face picture data, which has been obtained by imaging with the digital camera of the imaging means 2 installed in the shop, and the ticket data, are transmitted via the network N1 to the shop server 4 and thence via the network N2 to the headquarter server 5. The transmitted data is stored in memories or like storing means provided in the individual servers, and is read out as desired for managing. The face picture data is printed in and issued as ticket data as shown in 2 from the printer 3 belonging to the POS terminal 1. The ticket with face picture thereon, which is obtained by this printing, is delivered to the customer on the site.

In an event place, an outside terminal 6 is installed, which is connected via the network N3 to the headquarter server 5. The outside terminal 6 can receive the face photograph data and customer data stored in the memory of the headquarter server 5 and display the received data on the display. Thus, visual identity confirmation of the customer, who visits the event on a pertinent day, can be made by showing the ticket with face picture thereon carried by him or her to the personnel in charge. In case if the identity confirmation is difficult with the picture on the ticket with face picture thereon, it is possible to effect more accurate identify confirmation by receiving the face picture data and customer data of the pertinent ticket from the headquarter server 5 via the network N3.

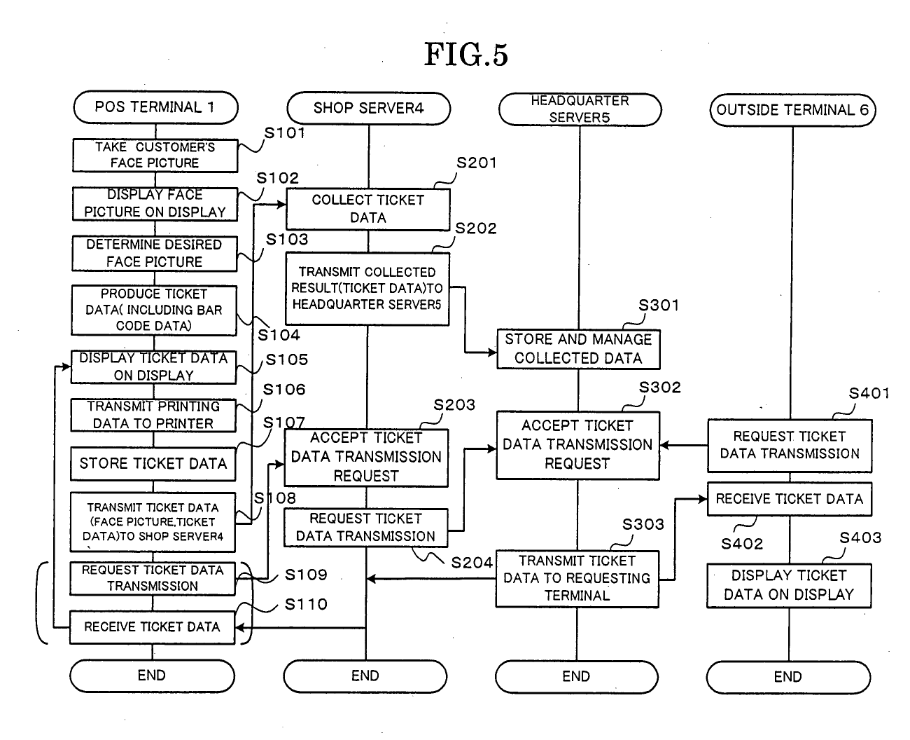

The operation routine of the method of issuing tickets with face picture by the data terminal according to the present invention will now be described with reference to a flow chart shown in FIG. 5.

On the side of the POS terminal (data terminal 1), a process of taking a customer's face picture with the digital camera 2 (step 101), a process of displaying face picture data imaged as a plurality of pictures on the display screen (step 102), a process of determining a desired face picture among these pictures (step 103), a process of producing the ticket data with face picture thereon and inclusive of the bar code as shown in FIG. 3 (step 104) and a process of displaying ticket data produced on the display screen (step 105), are executed. The ticket with face picture thereon, which is obtained in this way, is transmitted as printing data to the printer 3 (step 106) and also stored as ticket data (i.e., intrinsic ticket data, face picture data, bar code data, etc.) in the memory (step 107).

When the ticket data (such as face picture data and ticket data) is transmitted to the shop server 4 (step 108), the shop server 4 collects the received ticket data (step S201), and stores the collected data in its internal memory. Then, collection result (i.e., ticket data) is transmitted to the headquarter server 5 (step S202). The headquarter server 5 receiving the collection data transmitted from the shop server 4, stores and manages the received data (step S301).

When a ticket data transmission request to the shop server 4 is produced on the side of the POS terminal 1 (step S109), the shop server 4 accepts the ticket data transmission request (step S203), and requests ticket data transmission to the headquarter server 5 (step S204).

The headquarter server 5 accepts the ticket data transmission request from the shop server 4 (step S302), and transmits ticket data to the requesting terminal (step S303). The ticket data thus transmitted is received by the POS terminal 1 via the shop server 4 (step S110).

When it is difficult to confirm the identity of a customer visiting an event place with the photograph of the ticket with face picture thereon carried by the customer due to contamination or leakage of the ticket, the outside terminal 6 requests the transmission of the face picture data and the customer data of the pertinent ticket to the headquarter server 5 (step S401). Then, the headquarter server 5 accepts the ticket data transmission request from the outside terminal 6 (step S302), and transmits the ticket data to the outside terminal 5, i.e., the requesting terminal (step S303). The outside terminal 6 receives the ticket data thus transmitted (step S402), and displays this ticket data on the display screen (step S403). The identity confirmation can be made by observing the customer data and ticket data displayed on the display screen.

Although the method of issuing tickets with face picture thereon has been described, this is offered by way of illustration only.

Advantages of the Invention

As has been described in the foregoing, with the method of issuing tickets with face picture thereon from a data terminal according to the present invention, the following pronounced advantages are obtainable. Since a POS terminal or like data terminal is provided with a face picture taking means for printing tickets with face photograph thereon, it is possible to deliver a ticket with face picture thereon to a customer on the site. Also, since the printer used is a thermal printer for printing face pictures in a density gradation system, it is possible to obtain printing with brightness, i.e., obtain a print permitting ready face discrimination. Since the face picture data is stored in a memory, it is possible to readily manage face data as well as ticket data, and the identity confirmation can be accurately made with the display of stored face picture data on a display at an event hale entrance. Furthermore, an amusement park ticket can also be used as a passport to dispense with issuance of any new ticket.

What is claimed is:

1. A method of issuing tickets with face picture thereon from a data terminal, wherein customer's face picture data obtained by imaging with an imaging means installed on the side of the data terminal is printed together with ticket data on a ticket in a printer in the data terminal, the resultant printed ticket being issued, the face picture data and the ticket data being stored for management.

2. A method of issuing tickets with face picture thereon from a data terminal, wherein a data terminal, an imaging means and a printer are provided on the side of a ticket sales shop, and customer's face picture data obtained by imaging with an imaging means is printed together with ticket data on a ticket to be issued and also transmitted via a network to an upper rank server for storing and management.

3. The method of issuing tickets with face picture thereon from a data terminal according to claim 2, wherein an outside terminal connected via a network to the upper rank server is installed in a place, in which an event is held, for receiving face picture data and ticket data stored in the upper rank server and displaying the received data on a display for the confirmation of the customer.

4. The method of issuing tickets with face picture thereon according to claim 1, wherein the data terminal is a POS terminal.

5. The method of issuing tickets with face picture thereon according to claim 1, wherein the printer is a thermal printer, and the face picture is expressed by density gradation expression.

6. The method of issuing tickets with face picture thereon according to claim 2, wherein the data terminal is a POS terminal.

7. The method of issuing tickets with face picture thereon according to claim 2, wherein the printer is a thermal printer, and the face picture is expressed by density gradation expression.

8. The method of issuing tickets with face picture thereon according to claim 2, wherein the network comprises a communication line.
